(19) United States
(12) Patent Application Publication
(10) Pub. No.: US 2008/0242751 A1
(43) Pub. Date: Oct. 2, 2008

(54) PROCESSES FOR MANUFACTURING POLYESTERS FROM POST-CONSUMER POLYESTER

(76) Inventors: JOSEPH V. KURIAN, Hockessin, DE (US); YUANFENG LIANG, Chadds Ford, PA (US); F. GLENN GALLAGHER, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/866,076

(22) Filed: Oct. 2, 2007

Related U.S. Application Data
(60) Provisional application No. 60/882,072, filed on Dec. 27, 2006.

(51) Int. Cl. C08J 11/04; C08G 63/00

(52) U.S. Cl. 521/48.5; 528/272

(57) ABSTRACT

The present invention relates to processes for manufacturing polyesters The processes can be used for manufacturing polyesters from post-consumer polyesters. The processes include contacting a post-consumer polyester with at least one diol, at elevated temperature in presence of a catalyst, effecting a transesterification reaction. Biologically-derived diols can be used.

### FIELD OF THE INVENTION

The present invention relates to processes for manufacturing polyesters. The processes are particularly useful for manufacturing, from post-consumer polyesters, polyesters that have attributes and functionality substantially similar to virgin polyesters.

### BACKGROUND

Polyesters, such as polyethylene terephthalate (PET) and polybutylene terephthalate are used in a wide variety of application markets, including fibers, films, and engineering components. Tremendous amount of waste is generated each year from the use of these polyesters that has to be disposed off. Clearly, the disposal creates environmental problems. It would be desirable to reuse these wasted and post-consumer polyesters.

Conventional approaches to recycling polyesters have involved the separation and purification of either dimethyl terephthalate (DMT) or terephthalic acid (TPA) from the polyester and subsequent polycondensation of the DMT or TPA with ethylene glycol. Thus, recycling becomes energy intensive, and consequently a prohibitively expensive and process.

New and/or improved processes for using recycled polyesters are desired.

### SUMMARY OF THE INVENTION

One aspect of the present invention is a process for manufacturing polyesters from post-consumer polyester, comprising contacting the post-consumer polyester with at least one diol (e.g., 1,3-propanediol), at a temperature in the range of from about room temperature to about 300° C. in the presence of a polymerization catalyst. In some preferred embodiments, the catalyst comprises tin or titanium.

In some preferred embodiments, the post-consumer polyester is a post-industrial polyester.

Another aspect of the present invention is a polyester prepared by a process comprising contacting a post-consumer polyester with at least one diol, at a temperature in the range of from about room temperature to about 300° C. in the presence of a polymerization catalyst.

### DETAILED DESCRIPTION OF THE INVENTION

In the processes disclosed herein, common separation and purification steps used in conventional recycling processes are eliminated, lowering the cost of polymer manufacturing. Polymers produced from this approach can, in some embodiments, provide attributes and functionality similar to the virgin polyesters and an overall reduction in cost of manufacturing and energy use, lower emissions of greenhouse gases, and therefore, lower environmental footprint.

Unless otherwise defined, all technical and scientific terms used herein have the same meaning as commonly understood by one of ordinary skill in the art to which this invention belongs. In case of conflict, the present specification, including definitions, controls.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

“Room temperature” means generally ambient temperature; e.g., about 20-25° C.

When the term “about” is used in describing a value or an end-point of a range, the disclosure should be understood to include the specific value or end-point referred to.

The articles “a” or “an” are employed to describe elements and components of the invention. This is done merely for convenience and to give a general sense of the invention. This description should be read to include one or at least one, and the singular also includes the plural unless it is obvious that it is meant otherwise.

The materials, methods, and examples herein are illustrative only and, except as specifically stated, are not intended to be limiting.

Generally, the present invention provides processes for manufacturing polyesters, particularly from post-consumer polyester, comprising contacting the post-consumer polyester with at least one diol, at least at one temperature in the range of from about room temperature to about 300° C., in the presence of a catalyst.

In one embodiment, polyesters are manufactured from post-consumer polyester, by contacting the post-consumer polyester with at least one diol, at elevated temperature in presence of a catalyst, effecting a transesterification reaction. In a particular embodiment, the process provides poly(trimethylene terephthalate) polymer from post-consumer polyester comprising polyethylene terephthalate (PET), by transesterification reaction of the PET with 1,3-propanediol. In some preferred embodiments, the 1,3-propanediol is a biologically derived 1,3-propanediol.

In some embodiments, the post-consumer polyester comprises polymeric species selected from the group consisting of poly(ethylene terephthalate) (2GT or PET, or PETE), poly(trimethylene terephthalate) (PTT), poly(butylene terephthalate) (PBT or 4GT), poly(pentylene terephthalate) (5GT), poly(hexylene terephthalate) (6GT), poly(heptylene terephthalate) (7GT), polyether esters, mixtures thereof, blends thereof, and copolymers thereof. Polyester polymeric species may include PEN, 3GN and other naphthalene containing copolymers.

In some embodiments the diol is selected from the group consisting of C₂-C₂₀ alkanediols, polyalkylene diols, alkoxyalkanediol, alkenoxyalkanediol, alkenediol, glycols, polyether glycol, phenoxyalkanediol, alkylphenoxyalkanediol, phenylalkanediol, alkylphenylalkanediol, and haloalkanediols. In particular embodiments, the diol is selected from the group consisting of 1,3-propanediol, n-butane-1,3-diol, 2-methyl-1,3-propanediol, neopentyl glycol (2,2-dimethyl-1,3-propanediol), 1,4-butanediol, triethylene glycol, and mixtures thereof.

In one preferred embodiment, the diol is 1,3-propanediol. In some preferred embodiments, the diol is biologically derived. In preferred embodiments, the post-consumer polyester is derived from beverage bottles such as soda or water bottles comprising polyethylene terephthalate. In some preferred embodiments, the mole ratio of the 1,3-propanediol to the polyester is in the range of from about 5:1 to about 1:1, and the catalyst used is an organotitanate. As used herein, “derived from beverage bottles” means that beverage bottles are processed by, for example, chopping or grinding, to facilitate their use in the process for making polyester, and the thus-processed bottles containing post-consumer polyester are used to manufacture polyester according to a process of the present invention.

In some embodiments, wherein a biologically derived diol is used, the processes disclosed herein preferably utilize less energy than is typically required to make polyester from esterification of diacid or diester with a diol using a polycondensation catalyst.

In some embodiments, the process comprises contacting the post-consumer polyester with at least one diol, wherein the at least one diol is biologically derived 1,3 propanediol at a temperature in the range of from about 200° C. to about 300° C. in the presence of a catalyst. In preferred embodiments, the catalyst comprises tin or titanium.

In some embodiments, the process includes contacting post-consumer polyester comprising polyethylene terephthalate with the diol, wherein the at least one diol is 1,3 propanediol at a temperature in the range of from about 2000 to about 300° C. in the presence of a polymerization catalyst wherein the polyester is at least 80% 1,3 propanediol by weight, and PET is at most 20% by weight. For some applications, the polyester manufactured according to a process disclosed herein has an intrinsic viscosity in the range of from about 0.2 to about 2.0.

Polyesters made according to the processes disclosed herein can be used in articles and finished products such as, for example, apparel fibers, carpet fibers, upholstery, molded products, monofilaments, and packaging products.

By “post-consumer polyester” is meant polyester resulting after consumer or industrial use of the polyester. Thus, the “post-consumer polyester” may be termed “post-industrial polyester” if it has been used in industrial applications rather than household or other applications. The post-consumer polyester is used as a starting material.

Exemplary post-consumer polyesters include poly(ethylene terephthalate) (2GT or PET, or PETE), poly(trimethylene terephthalate) (PTT), poly(butylene terephthalate) (PBT or 4GT), poly(pentylene terephthalate) (5GT), poly(hexylene terephthalate) (6GT), poly(heptylene terephthalate) (7GT), and polyether esters such as Hytrel® polyether ester elastomeric polymer. Preferred post-consumer polyester for use in the processes disclosed herein comprises poly(ethylene terephthalate) identified by the recycling code 1. The post-consumer polyester, however, may also be in the form of a blend with one or more other polymeric materials. Polyester starting material present in the post-consumer polyester for use in the processes disclosed herein can contain, for example, thermoplastic elastomers based on polyesters.

For example, “polyester plastic waste” can be used. Suitable polyester plastic waste useful in the processes disclosed herein include recyclable products having a polyester component such as bottles, cups, containers, packaging materials, carpets, textiles, fiber waste, films, engineering components, molded and extruded articles, laminates, coatings, adhesives, etc. Preferred post-consumer polyester is derived from beverage bottles such as soda bottles and water bottles.

“Polyesters”, as the term is used herein, include polymeric and oligomeric species resulting from condensation reaction (polymerization or oligomerization) of dihydroxy compounds with polybasic acids. Suitable polybasic acids are the dibasic acids. Preferred are organic dibasic acids having the formula of HOOCACOOH in which A is an alkylene group, an arylene group, alkenylene group, or combinations of two or more thereof. Each A has about 2 to about 30, preferably about 3 to about 25, more preferably about 4 to about 20, and most preferably 4 to 15 carbon atoms per group. Examples of suitable organic acids include, but are not limited to, terephthalic acid, isophthalic acid, phthalic acid, 4,4′-diphenylene dicarboxylic acids, succinic acid, adipic acid, glutaric acid, bibenzoic acid, naphthalic acid, bis(p-carboxyphenyl)methane, 1,5-naphthalene dicarboxylic acid, 2,6-naphthalene dicarboxylic acid, 2,7-naphthalene dicarboxylic acid, 4,4′-sulfonyl dibenzoic acid, p-(hydroxyethoxy)benzoic acid, succinic acid, glutaric acid, adipic acid, sebacic acid, 1,12-dodecane dioic acid, and the derivatives thereof such as the dimethyl, diethyl, or dipropyl esters of these dicarboxylic acids, and combinations of two or more thereof.

The aliphatic or aromatic diacid or diester can be aliphatic (including cycloaliphatic) or aromatic, or a combination thereof, and is preferably selected from the group consisting of aromatic dicarboxylic acids and esters (preferably short chain alkyl esters, and more preferably methyl esters), and combinations thereof. Preferred are aliphatic or aromatic diacids, and most preferred are aromatic dicarboxylic acids and combinations thereof. Preferably the aliphatic or aromatic diacid is an aromatic diacid selected from the group consisting of terephthalic acid, isophthalic acid. Of these, terephthalic acid and isophthalic acid, and mixtures thereof are preferred, with terephthalic acid being most preferred.

Post-consumer polyester starting material, useful for the processes disclosed herein can be made from additional aromatic dicarboxylic acids or diesters described in U.S. Pat. No. 6,562,457, U.S. Pat. No. 6,599,625, and U.S. Pat. No. 7,144,972.

As stated hereinabove, post-consumer polyester that can be used in the processes disclosed herein includes waste that can also comprise thermoplastic elastomers (TPE) such as segmented copolyesters. Thermoplastic elastomers are a class of polymers which combine the properties of two other classes of polymers, namely thermoplastics, which may be reformed upon heating, and elastomers which are rubber-like polymers. One form of TPE is a block copolymer, usually containing some blocks whose polymer properties usually resemble those of thermoplastics, and some blocks whose properties usually resemble those of elastomers. Those blocks whose properties resemble thermoplastics are often referred to as “hard” segments, while those blocks whose properties resemble elastomers are often referred to as “soft” segments.

Preferred polyesters are those resulting from esterification of dimethyl terephthalate, terephthalic acid, or isophthalic acid with diols. Polyesters also include copolyesters having either at least one type of the acid component of the repeat unit and/or at least one type of the diol component in the repeat unit.

In the present processes, post-consumer polyester is treated with one or more diols to effect a transesterification reaction. Suitable diols include C₂-C₂₀ alkanediols, alkoxy C₂-C₂₀ alkanediol, alkenoxy C₂-C₂₀ alkanediol, C₂-C₂₀ alkenediol, phenoxy C₂-C₂₀ alkanediol, alkylphenoxy C₂-C₂₀ alkanediol, phenyl C₂-C₂₀ alkanediol, alkylphenyl C₂-C₂₀ alkanediol, and halo C₂-C₂₀ alkanediol. Preferred diols include linear or branched chain C₂-C₂₀ alkanediol, for example, ethylene glycol, diethylene glycol, di-, tri- or tetraethylene glycol, di.-, tri- or tetrapropylene glycol and di-, tri- or tetrabutylene glycol, 1,2-propanediol, isopropylene glycol, 1-methyl propylene glycol, 1,3-propanediol, n-butane-1,3-diol, 2-methyl-1,3-propanediol, neopentyl glycol (2,2-dimethyl-1,3-propanediol), 2-methyl-1,3-propanediol, 2,2-diethyl-1,3-propanediol, 2-ethyl-2-(hydroxymethyl)-1,3-propanediol, 1,4-butanediol, triethylene glycol, 1,5-pentanediol, 1,6-hexanediol, 1,2-, 1,3-, and 1,4-cyclohexanedimethanol, 1,7-heptanediol, 1,8-octanediol, 1,9-nonanediol, 1,10-decanediol, 1,12-dodecanediol, 3,3,4,4,5,5-hexafluoro-1,5-pentanediol, 2,2,3,3,4,4,5,5-octafluoro-1,6-hexanediol, and 3,3,4,4,5,5,6,6,7,7,8,8,9,9,10,10-hexadecafluoro-1,12-dodecanediol. Also preferred are cycloaliphatic diols, for example 1,4-cyclohexanediol, 1,4-cyclohexanedimethanol and isosorbitol. A particularly preferred diol is 1,3-propanediol (PDO). More particularly preferred is biologically derived (“bio-derived”) 1,3-propanediol.

By 1,3-propanediol (PDO) is meant a reactant comprising at least one of 1,3-propanediol, 1,3-propanediol dimer and 1,3-propanediol trimer, or mixtures thereof. The 1,3-propanediol reactant employed in the process of the present invention may be obtained by any of the various chemical routes or by biochemical transformation routes. Preferred routes are described in U.S. Pat. No. 5,015,789, U.S. Pat. No. 5,276,201, U.S. Pat. No. 5,284,979, U.S. Pat. No. 5,334,778, U.S. Pat. No. 5,364,984, U.S. Pat. No. 5,364,987, U.S. Pat. No. 5,633,362, U.S. Pat. No. 5,686,276, U.S. Pat. No. 5,821,092, U.S. Pat. No. 5,962,745, U.S. Pat. No. 6,140,543, U.S. Pat. No. 6,232,511, U.S. Pat. No. 6,235,948, U.S. Pat. No. 6,277,289, U.S. Pat. No. 6,284,930, U.S. Pat. No. 6,297,408, U.S. Pat. No. 6,331,264, U.S. Pat. No. 6,342,646, US2004/0225161A1, US2004/0260125A1, US2005/0069997A1. Preferably the PDO used as the reactant or as a component of the reactant will have a purity of greater than about 99% by weight as determined by gas chromatographic analysis.

Although any of PDO, and dimers or trimers of PDO can be used as the diol in the process, it is preferred that the reactant comprise about 90% or more by weight of PDO. More preferably, the reactant will comprise 99% or more by weight of PDO.

A further preferred PDO is a bio-derived PDO. A bio-derived PDO is a PDO that is synthesized via iochemical routes. Biochemical routes to PDO have been described that utilize feedstocks produced from biological and renewable resources such as corn feed stock. For example, bacterial strains able to convert glycerol into 1,3-propanediol are found in e.g., in the species Klebsiella, Citrobacter, Clostridium, and Lactobacillus. The technique is disclosed in several patents, including, U.S. Pat. No. 5,633,362, U.S. Pat. No. 5,686,276, and, U.S. Pat. No. 5,821,092, all of which are incorporated herein by reference. In U.S. Pat. No. 5,821,092, Nagarajan, et al. disclose, inter alia, a process for the biological production of 1,3-propanediol from glycerol using recombinant organisms. The process incorporates E. Coli bacteria, transformed with a heterologous pdu diol dehydratase gene, having specificity for 1,2-propanediol. The transformed E. Coli is grown in the presence of glycerol as a carbon source and 1,3-propanediol is isolated from the growth media. Since both bacteria and yeasts can convert glucose (e.g., corn sugar) or other carbohydrates to glycerol, the process of the invention provided a rapid, inexpensive and environmentally responsible source of 1,3-propanediol monomer useful in the production of polyesters, polyethers, and other polymers.

When 1,3-propanediol is the diol used in the present processes it may also contain small amounts, preferably no more than about 30%, more preferably no more than about 10%, by weight, of the starting material, or of comonomer diols in addition to the reactant 1,3-propanediol, or of its dimers and trimers without detracting from the efficacy of the process. Examples of preferred comonomer diols include ethylene glycol, 2-methyl-1,3-propanediol, 2,2-dimethyl-1,3 propanediol, and C₆-C₁₂ diols such as 2,2-diethyl-1,3-propanediol, 2-ethyl-2-hydroxymethyl-1,3-propanediol, 1,6-hexanediol, 1,8-octanediol, 1,10-decanediol, 1,12-dodecanediol, 1,4-cyclohexanediol and 1,4-cyclohexanedimethanol. A more preferred comonomer diol is ethylene glycol.

In a preferred embodiment, the present process converts post-consumer polyester plastic, by reacting such plastic with 1,3-propanediol in the presence of a catalyst under a nitrogen atmosphere at temperatures in the range of about 200° C. to about 300° C. Organo titanate such as Tyzor® TPT tetra isopropyl titanate is useful as a catalyst for this process. The resulting copolymer comprises a relatively higher fraction (e.g., more than 50%) of poly(trimethylene terephthalate) polymer with a smaller fraction of 2GT-based repeat units. In some embodiments, the amount of poly(trimethylene terephthalate) is 70% or higher, even 95% or higher.

In another preferred embodiment, the present process converts post-consumer polyester (waste) based on PET, by reacting such polyester with 1,3-propanediol in the presence of a catalyst under a nitrogen atmosphere at temperatures in the range of about 200° C. to about 300° C. Organo titanates such as Tyzor® TPT tetra isopropyl titanate are useful as a catalyst. The resulting polymer is a copolyester comprising ethoxy and butoxy repeat units. The term “at least one diol” as used herein means that, in some embodiments, at least two different diols are used.

The present processes are carried out using a catalyst. In preferred embodiments, the catalyst comprises tin and/or titanium. Any tin-containing compounds that can be used as an esterification catalyst can be used. Generally, the catalyst can be an inorganic tin compound or an organic tin compound. Examples of suitable tin compounds include, but are not limited to, n-butylstannoic acid, octylstannoic acid, dimethyltin oxide, dibutyltin oxide, dioctyltin oxide, diphenyltin oxide, tri-n-butyltin acetate, tri-n-butyltin chloride, tri-n-butyltin fluoride, triethyltin chloride, triethyltin bromide, triethyltin acetate, trimethyltin hydroxide, triphenyltin chloride, triphenyltin bromide, triphenyltin acetate, or combinations of two or more thereof. Tin oxide catalysts are preferred. These tin compounds are generally commercially available. For example, n-butylstannoic acid can be obtained from the Witco Chemical Corp., Greenwich, Conn.

Preferred titanium compounds are organic titanium compounds. Titanium dioxide can also be used. Titanium tetrahydrocarbyloxides, also referred to as tetraalkyl titanates herein, are presently most preferred organic titanium compounds because they are readily available and effective. Examples of suitable titanium tetrahydrocarbyloxide compounds include those expressed by the general formula Ti(OR)₄ where each R is individually selected from an alkyl or aryl radical containing from 1 to about 30, preferably 2 to about 18, and most preferably 2 to 12 carbon atoms per radical and each R can be the same or different. Titanium tetrahydrocarbyloxides in which the hydrocarboxyl group contains from 2 to about 12 carbon atoms per radical which is a linear or branched alkyl radical are most preferred because they are relatively inexpensive, more readily available, and effective in forming the solution. Suitable titanium tetrahydrocarbyloxides include, but are not limited to, titanium tetraethoxide, titanium tetrapropoxide, titanium tetraisopropoxide, titanium tetra-n-butoxide, titanium tetrahexoxide, titanium tetra 2-ethylhexoxide, titanium tetraoctoxide, and combinations of two or more thereof.

Suitable titanium tetrahydrocarbyloxides can be produced by, for example, mixing titanium tetrachloride and an alcohol in the presence of a base, such as ammonia, to form the titanium tetracarbyloxide or tetraalkyl titanate. The alcohol can be ethanol, n-propanol, isopropanol, n-butanol, or isobutanol. Titanium tetrahydrocarbyloxides thus produced can be recovered by first removing by-product ammonium chloride by any means known to one skilled in the art such as filtration followed by distilling the titanium tetrahydrocarbyloxides from the reaction mixture. This process can be carried out at a temperature in the range of from about 0 to about 150° C. Titanates having longer alkyl groups can also be produced by transesterification of those having R groups up to C₄ with alcohols having more than 4 carbon atoms per molecule. Examples of commercially available organic titanium compounds include, but are not limited to, TYZOR®TPT tetra isopropyl titanate and TYZOR® TBT tetra n-butyl titanate, available from E. I. du Pont de Nemours and Company, Wilmington, Del., U.S.A.

If catalysts containing both tin and titanium are used, the weight ratio of the tin compound to the titanium compound can be any ratio so long as the ratio can catalyze the esterification of an acid and 1,3-propanediol. Generally, the ratio can be about 0.01:1 to about 100:1 and preferably about 0.1:1 to about 10:1.

The catalyst can be produced by any method known to one skilled in the art. For example, the catalyst can be produced by separately combining the tin compound or titanium compound with the acid or 1,3-propanediol in an esterification medium. The catalyst can also be produced in situ in an esterification medium by combining the tin compound or titanium compound with the acid, 1,3-propanediol, or both. Preferably, it is produced by combining the tin compound or titanium compound before the contacting with the esterification medium. In other words, it is preferred that a premixed catalyst comprising, consisting essentially of, or consisting of the tin compound and the titanium compound be produced before being contacted with the esterification medium. More preferably, the tin and titanium catalysts are mixed in an organic solvent before being used in the process. Any solvent that can substantially dissolve or disperse the catalyst and does not interfere with polymerization can be used. For convenience, the organic solvent can be 1,3-propanediol. Preferably, tin is present in an amount between about 2 and 400 ppm and titanium is present in an amount between about 2 and 400 ppm, each elemental amount based on the weight of reactants in the esterification medium.

The present processes also allow control of the ratio of the acid repeat units to the alkoxy repeat units, by controlling the initial molar ratio of the alkanediol to polyester in the post-consumer polyester. In a preferred embodiment, the mole ratio is in the range of from about 100:1 to about 1:1 of alkanediol to polyester in the post-consumer polyester. A further preferred mole ratio is in the range of 5:1 to about 1:1 of the alkanediol to polyester in the post-consumer polyester.

The transesterification reaction of the process can be effected in a preferred temperature range of from about 200° C. to about 300° C. In one embodiment the temperature may be maintained at one point for the entire reaction. In another embodiment, the temperature may be maintained for different or same periods of time at more than one temperature points, once or more than once.

Conventional additives can be incorporated into the polyester product of the process by addition during esterification. Suitable additives include delusterants (e.g., TiO₂, zinc sulfide or zinc oxide), colorants (e.g., dyes), stabilizers (e.g., antioxidants, ultraviolet light stabilizers, heat stabilizers, etc.), fillers, flame retardants, pigments, antimicrobial agents, antistatic agents, optical brighteners, extenders, processing aids, viscosity boosters, and other functional additives.

The polyesters made by the present process can generally be used in any applications in which polyesters obtained from esterification of a diacid or diester with a diol. For example, the polyester can be used to make fibers for use in all fiber applications such as apparels, textiles, carpets, cords, tire components, woven materials, nonwoven materials, packaging materials, engineering applications such as molded parts, extruded parts, laminated parts, insulation, electrical insulation, automotive parts, exterior and interior, bottles, beverage bottles, and other containers. The polyesters can also be used to make films, including injection molded articles, injection stretch blow molded articles, and other shaped articles. For example, the polyester can be used to make continuous fibers (for example, those used in textile end uses such as fabric used for clothing, as well as in carpet fibers including bulked continous filament (BCF) fiber), and staple fibers (such as those used in textile end uses including fabric used in clothing, carpet fibers, upholstery fibers, and automotive fiber end uses.

### EXAMPLES

### Example 1

### poly(trimethylene terephthalate) Sorona® Polymer from PET

A 250 ml, three-necked flask was charged with 60 g of PET-3934 (obtained from E. I. du Pont de Nemours & Co., Wilmington, Del.) and 38 g of bio-PDO (obtained from E. I. du Pont de Nemours & Co., Wilmington, Del.) for a PDO:PET polymer mole ratio of 1.6:1. Tyzor® TPT tetra isopropyl titanate (36 mg) was added as catalyst to the polymerization mixture.

The temperature was raised gradually to 230° C. with the reaction mixture under a nitrogen environment. The temperature was held at 230° C. for about 1 hour. Temperature was further raised to 250° C. and held at 250° C. under a vacuum of 0.2 mm (2.66×10⁻⁵ MPa) for 1.5 hour. At the end of the reaction, the flask was cooled and polymer was collected.

The resulting polymer had a melting point of 209° C., and intrinsic viscosity (IV) of 0.85 dL/g. Polymer IV is the intrinsic viscosity of the polymer and is defined as reduced viscosity in infinite dilute solution of the polymer or limit value of inherent viscosity. The weight ratio of poly(trimethylene terephthalate) to that of PET by NMR was 85:15.

### Example 2

### poly(trimethylene terephthalate) Sorona® Polymer from PET

A 250 ml, three-necked flask was charged with 60 g of PET-3934 and 71 g of bio-PDO for a PDO:PET polymer mole ratio of about 3:1. Tyzor® TPT tetra isopropyl titanate (36 mg) was added as catalyst to the polymerization mixture. The temperature was raised gradually to 220° C. with the reaction mixture under a nitrogen environment. The temperature was held at 230° C. for about 1 hour. Temperature was further raised to 250° C. and held at 250° C. under a vacuum of 0.2 mm (2.66×10⁻⁵ MPa) for 1.5 hour. At the end of the reaction, the flask was cooled and polymer was collected.

The resulting polymer had a melting point of 220.5° C., and IV of 0.81 dL/g. The weight ratio of poly(trimethylene terephthalate) to that of PET by NMR was 93:7.

### Example 3

### Sorona® Copolymer from PBT

A 250 ml, three-necked flask was charged with 65 g of PBT (obtained from E. I. du Pont de Nemours & Co., Wilmington, Del.) and 76 g of bio-PDO (for a PDO:PBT polymer mole ratio of about 3:1). Tyzor® TPT tetra isopropyl titanate (36 mg) was added as catalyst to the polymerization mixture. The temperature was raised gradually to 220° C. with the reaction mixture under a nitrogen environment. The temperature was held at 220° C. for about 1 hour. Temperature was further raised to 250° C. and held at 250° C. under a vacuum of 0.2 mm (2.66×10⁻⁵ MPa) for 1 hour. At the end of the reaction, the flask was cooled and polymer was collected.

The resulting polymer had a melting point of 195° C., and an IV of 0.88 dL/g. The weight ratio of poly(trimethylene terephthalate) to that of PBT by NMR was 72:28.

### Example 4

### poly(trimethylene terephthalate) Sorona® Polymer from PET

A 25 gallon autoclave was charged with 100 lbs. of PET-3934 and 80 lbs. of bio-PDO for a PDO:PET polymer mole ratio of about 2:1. Tyzor® TPT tetra isopropyl titanate (17 g) was added as catalyst to the polymerization mixture. The temperature was raised gradually to 230° C. with the reaction mixture under a nitrogen environment. The temperature was held at 230° C. for about 1 hour. Temperature was further raised to 250° C. and held at 250° C. under a vacuum of 0.2 mm (2.66×10⁻⁵ MPa) for 4 hours. At the end of the reaction, the polymer was pelletized.

The resulting polymer had a melting point of 214.8° C., and IV of 0.76 dL/g. The weight ratio of poly(trimethylene terephthalate) to that of PET by NMR was 90:10.

### Example 5

### poly(trimethylene terephthalate) Sorona® Polymer from PET

A 25 gallon autoclave was charged with 100 lbs. of PET-3934 and 118 lbs. of bio-PDO for a PDO:PET polymer mole ratio of about 3:1. Tyzor® TPT tetra isopropyl titanate (18 g) was added as catalyst to the polymerization mixture. The temperature was raised gradually to 230° C. with the reaction mixture under a nitrogen environment. The temperature was held at 230° C. for about 1 hour. Temperature was further raised to 250° C. and held at 250° C. under a vacuum of 0.2 mm (2.66×10⁻⁵ MPa) for 4.5 hours. At the end of the reaction, the polymer was pelletized.

The resulting polymer had a melting point of 219° C., and IV of 0.82 dL/g. The weight ratio of poly(trimethylene terephthalate) to that of PET by NMR was 95:5.

What is claimed is:

1. A process for manufacturing polyesters from post-consumer polyester, comprising contacting the post-consumer polyester with at least one diol, at a temperature in the range of from about room temperature to about 300° C., in the presence of a polymerization catalyst.

2. The process of claim 1 wherein the catalyst is selected from the group consisting of tin catalysts, antimony catalysts, germanium catalysts and titanium catalysts.

3. The process of claim 1 wherein the catalyst is selected from the group consisting of tin catalysts and titanium catalysts.

4. The process of claim 1, wherein the post-consumer polyester is derived from polyester articles made from polyester with a recycling code 1.

5. The process of claim 1 wherein the post-consumer polyester comprises polymeric species selected from the group consisting of poly(ethylene terephthalate), poly(trimethylene terephthalate), poly(butylene terephthalate), poly(pentylene terephthalate), poly(hexylene terephthalate), poly(heptylene terephthalate), polyether esters, mixtures thereof, blends thereof, and copolymers thereof.

6. The process of claim 1, wherein the at least one diol is selected from the group consisting of C₂-C₂₀ alkanediols, polyalkylene diols, alkoxyalkanediol, alkenoxyalkanediol, alkenediol, glycols, polyether glycol, phenoxyalkanediol, alkylphenoxyalkanediol, phenylalkanediol, alkylphenylalkanediol, and haloalkanediol.

7. The process of claim 6, wherein the at least one diol is selected from the group consisting of 1,3-propanediol, n-butane-1,3-diol, 2-methyl-1,3-propanediol, neopentyl glycol (2,2-dimethyl-1,3-propanediol), 1,4-butanediol, triethylene glycol, and mixtures thereof.

8. The process of in claim 1, wherein the 1,3-propanediol is biologically derived.

9. The process of claim 1, wherein the polyester comprises polyethylene terephthalate.

10. The process of claim 1 wherein the mole ratio of the at least one diol, to the polyester in the post-consumer polyester, is in the range of from about 100:1 to about 1:1.

11. The process of claim 10, wherein the mole ratio of the diol to the polyester is in the range of from about 5:1 to about 1:1.

12. The process as recited in claim 10, wherein the catalyst is an organic titanate.

13. A process for manufacturing polyesters from post-consumer polyester, comprising contacting the post-consumer polyester with at least one diol, wherein the at least one diol is a bio-derived diol, at a temperature in the range of from about 160° C. to about 300° C. in the presence of a catalyst comprising tin or titanium.

14. A polyester prepared by the process of claim 1.

15. A polyester prepared by the process of claim 14, wherein the polyester is at least 80% poly(trimethylene terephthalate) by weight, and PET is at most 20% by weight.

16. A finished article made from the polyester of claim 14.

17. A fiber comprising a polyester of claim 14.

18. A molded product comprising a polyester of claim 14.

19. A packaging product comprising a polyester of claim 14.

20. The polyester of claim 14, said polyester having an intrinsic viscosity of from about 0.2 to about 2.0.

21. The process of claim 1 wherein the catalyst is titanium dioxide.
